(19) United States
(12) Patent Application Publication
(10) Pub. No.: US 2026/0336981 A1
(43) Pub. Date: Oct. 29, 2026

(54) EVALUATION OF A STATE OF AN ELEVATOR DOOR

(71) Applicant: KONE Corporation, Helsinki (FI)

(72) Inventors: Matti Mustonen, Helsinki (FI); Petri Kuisma, Helsinki (FI); Matti Lin, Helsinki (FI); Serge Roosendaal, Helsinki (FI)

(73) Assignee: KONE Corporation, Helsinki (FI)

(21) Appl. No.: 19/559,137

(22) Filed: Mar. 6, 2026

(30) Foreign Application Priority Data
Apr. 28, 2025 (EP) 25172859.8

(51) Int. Cl. B66B 13/14; B66B 5/02; B66B 13/06

(52) U.S. Cl. CPC B66B 13/146; B66B 5/02; B66B 13/06

(57) ABSTRACT

A method for evaluating a distance of elevator door lock rollers of an elevator door is provided, the method, performed by a computing system, includes: determining an indicator value of the distance of the elevator door lock rollers; comparing the indicator value to a reference value; setting a detection result to express one of the following: i) the distance is in allowable range, ii) the distance deviates from the allowable range. Also, a computing system and a computer readable medium storing a program are provided.

### TECHNICAL FIELD

The invention concerns in general the technical field of elevators. More particularly, the invention concerns elevator doors.

### BACKGROUND

Correct operation of elevator doors is an important aspect in terms of safety and convenience of elevator passengers. In particular, timely opening the doors to enable passengers to enter and exit an elevator car plays an important role in avoiding undue delays in passenger transport, while ensuring that doors can be opened when the elevator car is in a position that enables safe movement between the elevator and a landing of the elevator system and ensuring that doors remain closed when the elevator car is in transit between landings is an important aspect of passenger safety.

In many elevator systems the elevator doors are automatically operated such that opening and closing the elevator doors is carried out via using a driving system arranged in the elevator car, which driving system comprises an electric motor arranged to drive movement of the elevator doors under control of an elevator door controller. The elevator doors typically refer to an implementation in which the landing comprises so-called landing door(s) whereas the elevator car comprises so-called car door(s). The synchronous operation of these two is arranged with so-called coupler mechanism wherein the landing door and the elevator car door are arranged to be coupled together so as to achieve a synchronous opening/closing cycle.

The coupler mechanism may be established with a combination of so-called elevator door lock rollers of the landing door and coupler vanes of the elevator car door to ensure safe and smooth operation. An example of the coupling mechanism is schematically illustrated in FIGS. 1A and 1B. The interaction between the door lock rollers 110 of the landing door 130 and the coupler vanes 120 of the car door 140 is such that when the elevator car travels vertically between floors the door lock rollers 110 end up to a slot formed between the coupler vanes 120 of the elevator car when the elevator car reaches the landing. When the car door is instructed to move, e.g. to open, the coupler vanes 120 reach at least one of the lock rollers 110 so as to couple the landing door 130 to move together with car door 140.

The distance between the lock rollers 110 plays an important role in the operation of the coupler mechanism and the elevator door in general. The installation of the lock rollers 110 is performed by a technician and there may occur errors already in the installation as the structure of the lock roller allows an adjustment of the position of the lock roller in its position (cf. the mounting plate of the lock roller comprises a screw slot enabling adjustment). Moreover, the initial position of the lock roller may change during an operation of the elevator door and the coupling mechanism. Commonly known problems originating from that the distance of the lock rollers is too wide are at least the following:
may cause a lock jamming in the car door or the landing door
the lock roller(s) may hit the coupler vane(s) during a travel of the elevator car (causing emergency stop and even entrapment due to safety circuit opening)

Correspondingly, the mutual distance between the lock rollers may be too small and that prevents the opening of the doors due to that the door lock does not open. This is because the coupling mechanism is also involved in locking the elevator doors with a locking assembly comprising a lock latch, typically comprising a lock latch hook, and a lock counterpart that is engaged with the hook portion of the latch.

As described, the nonoptimal positioning of the lock rollers with respect to each other leads to a functional failure and the use of the elevator is prevented. To solve the situation a technician is called to visit the premises of the elevator and fix the issue by re-adjusting the positions of the lock rollers properly.

Generally speaking, the installation and the adjustment of the lock rollers 110 is not easy task due to finding the optimal positions for the lock rollers 110 as well as a tightening of the screws, or corresponding fixing means, shall be optimal. These root reasons among the others make the malfunctioning of the elevator door possible as described.

In view of the drawbacks caused by an error in the distance between the lock rollers 110 there is a need to introduce solutions by means of which the malfunctioning of the elevator door, and even the elevator, may be prevented, or at least mitigated.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a computing system, an elevator system, and a computer program for evaluating a distance of elevator door lock rollers of an elevator door.

The objects of the invention are reached by a method, a computing system, an elevator system, and a computer program as defined by the respective independent claims.

According to a first aspect, a method for evaluating a distance of elevator door lock rollers of an elevator door is provided, the method, performed by a computing system, comprises:
determining, on the basis of data descriptive of the distance of the elevator door lock rollers, an indicator value of the distance of the elevator door lock rollers,
comparing the indicator value to a reference value,
setting, in accordance with a comparison between the indicator value and the reference value, a detection result to express one of the following: i) the distance is in allowable range, ii) the distance deviates from the allowable range.

The data descriptive of the distance of the elevator door lock rollers may correspond to data representing a characteristic of an elevator door motor during an opening cycle of the elevator door. For example, the data representing a characteristic of an elevator door motor may be received over a monitoring period during the opening cycle of the elevator door, the monitoring period corresponds to a compression period of the elevator door comprising elevator door lock rollers positioned in an allowable distance from each other. Moreover, the at least one characteristic may be at least one of the following: a force of a door belt generated by the elevator door motor during the opening cycle of the elevator door; a torque generated by the elevator door motor during the opening cycle of the elevator door; an input current of the elevator door motor during the opening cycle of the elevator door.

The indicator value may e.g. be determined as at least one of the following: an integral of the characteristic of the elevator door motor over instants of time, t₀, t₁ defining the monitoring period; an integral of the characteristic of the elevator door motor over positions of door belt, s₀, s₁, defining the monitoring period; an integral of the characteristic of the elevator door motor over speeds of door belt v₀, v₁ defining the monitoring period.

On the other hand, the reference value may be determined over the monitoring period wherein the distance of the elevator door lock rollers is allowable.

Still further, the method may further comprise:
generating a request of a maintenance visit to a maintenance system in response to a setting of the detection result to express that the distance deviates from the allowable range.

According to a second aspect, a computing system for evaluating a distance of elevator door lock rollers of an elevator door is provided, the computing system is configured to:
determine, on the basis of data descriptive of the distance of the elevator door lock rollers, an indicator value of the distance of the elevator door lock rollers,
compare the indicator value to a reference value,
set, in accordance with a comparison between the indicator value and the reference value, a detection result to express one of the following: i) the distance is in allowable range, ii) the distance deviates from the allowable range.

The data descriptive of the distance of the elevator door lock rollers may correspond to data representing a characteristic of an elevator door motor during an opening cycle of the elevator door. For example, the computing system may be configured to receive the data representing a characteristic of an elevator door motor over a monitoring period during the opening cycle of the elevator door, the monitoring period corresponds to a compression period of the elevator door comprising elevator door lock rollers positioned in an allowable distance from each other. Still further, the at least one characteristic may be at least one of the following: a force of a door belt generated by the elevator door motor during the opening cycle of the elevator door; a torque generated by the elevator door motor during the opening cycle of the elevator door; an input current of the elevator door motor during the opening cycle of the elevator door.

The computing system may be configured to determine the indicator value as at least one of the following: an integral of the characteristic of the elevator door motor over instants of time, t₀, t₁, defining the monitoring period; an integral of the characteristic of the elevator door motor over positions of door belt, s₀, s₁, defining the monitoring period; an integral of the characteristic of the elevator door motor over speeds of door belt v₀, v₁ defining the monitoring period.

On the other hand, the computing system may be configured to determine the reference value over the monitoring period wherein the distance of the elevator door lock rollers is allowable.

The computing system may further be configured to:
generate a request of a maintenance visit to a maintenance system in response to a setting of the detection result to express that the distance deviates from the allowable range.

For example, the computing system may be at least one of: an elevator controller; an elevator door controller.

According to a third aspect, an elevator system is provided, the elevator system comprising:
an elevator door arranged moveable between an open position and a closed position;
a door driving system for driving a movement of the elevator door; and
a computing system according to the second aspect as defined above.

According to a fourth aspect, a computer program is provided, the computer program comprising instructions to cause the computing system according to the second aspect as defined above to execute the steps of the method of according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIGS. 1A and 1B illustrate schematically a coupling mechanism of an elevator door from various viewpoints.

FIG. 2A illustrates schematically some aspects of an elevator system according to an example.

FIG. 2B illustrates schematically a block diagram of some logical elements of an elevator control system according to an example.

FIG. 3 illustrates schematically a method according to an example.

FIG. 4 illustrates schematically some aspects in relation to mutual positions of door lock rollers of an elevator according to an example.

FIGS. 5A and 5B illustrate schematically some aspects of an operation of an elevator door according to an example.

FIG. 6 illustrates schematically a graph representing aspects in relation to elevator door opening cycle according to an example.

FIG. 7 illustrates schematically a computing system according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

In broad terms, the present invention relates to an evaluation of a state of an elevator door. In other words, an evaluation of an operational state of the elevator door is performed through evaluating a distance of elevator door lock rollers of the elevator door wherein the distance under evaluation corresponds to distance of the elevator door lock rollers when the door is in a locked state. Specifically speaking, the elevator door lock rollers are typically arranged in a structure of a landing door of the elevator and the elevator door lock rollers are arranged to interact with a coupler vane assembly of a car door. However, in some embodiments the location of the elevator door lock rollers and the coupler vane assembly may be vice versa, i.e. the lock rollers are arranged in the car door structure whereas the coupler vane assembly is mounted to the landing door.

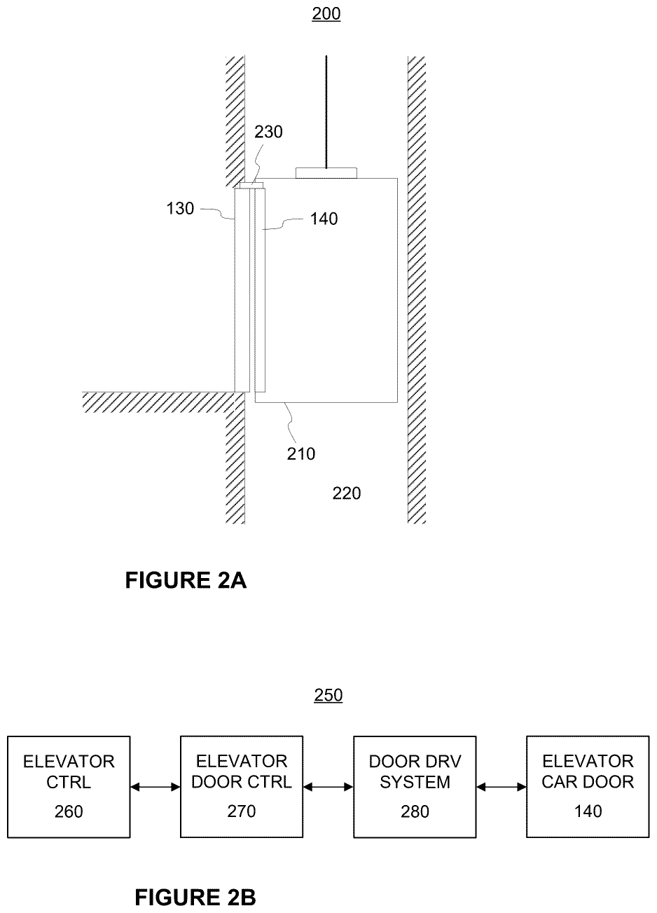

For avoidance of doubt, it is hereby referred to FIG. 2A in which some aspects of an elevator system 200 provided with automatic doors according to an example are schematically illustrated. The elevator system 200 comprises an elevator car 210 that may be moved in the vertical direction within an elevator shaft 220 to enable transporting passengers and/or cargo between landings of the elevators system 200. The elevator car 210 may be provided with a car door 140, wherein the car door 140 comprises a sliding door that is moveable between a closed position and an open position. The elevator 200 may further comprise a door coupler mechanism 230 that may be applied for temporarily coupling the car door 140 with a landing door 130 of the landing when the elevator car 210 resides within the landing zone of the landing such that when moving the car door 140 the landing door 130 moves between a closed position and an open position together with the car door 140.

The door coupler mechanism 230 may comprise coupling elements in the car door 140 and corresponding counter elements in the landing door 130 configured to engage each other upon moving the car door 140, thereby coupling the landing door 130 with the car door 140. In this regard, the coupling elements in the door coupler mechanism 230 are positioned with respect each other such that, when the elevator car 210 is moving along the elevator shaft 220 past the landing door 130, the coupling elements of the car door 140 are passed by the counter elements of the landing door 130. When the elevator car 210 is at the landing and the car door 140 is moved in order to open the landing door 130, the coupling elements of the car door 140 engage the counter elements of the landing door 130 and, consequently, when the car door 140 is moved by a door driving system arranged in the elevator car 210, the landing door 130 moves together with the car door 140.

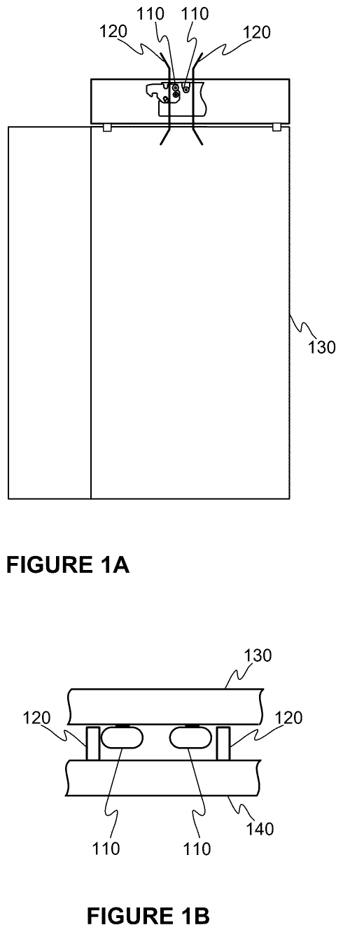

In an example, the coupling elements may be arranged in a (first) railing assembly provided in the elevator car 210 above the car door 140 for guiding the movement of the car door 140 between the open and closed positions, whereas the counter elements may be arranged in a (second) railing assembly provided in the landing above the landing door 130 for guiding the movement of the landing door 130 between the open and closed positions. As an example in this regard, the coupling elements may comprise coupler vanes 120 (provided e.g. as sheet-metal vanes) projecting towards the landing door 130, where the coupler vanes 120 may be arranged such that they form a vertical ‘slot’ that has its open end directed towards the landing door 130, whereas the counter elements may comprise at least two elevator door lock rollers 110 mounted on the landing door 130 in a position projecting towards the elevator shaft 220, the respective axes of the at least two elevator door lock rollers 110 being substantially perpendicular to the plane of the landing door 130. Herein we refer to the FIGS. 1A and 1B schematically illustrating aspects in relation of the coupling mechanism as described. As another example in this regard, the coupling mechanism may be implemented so that the coupler vanes 120 are arranged to end up between the elevator door lock rollers 110 when the elevator car 210 resides at the landing floor.

FIG. 2B illustrates a block diagram of some logical elements of an elevator control system 250 according to an example. The elevator control system 250 may serve to control various aspect related to movement and operation of the elevator car 210. In this example, the elevator control system 250 is shown with an elevator controller 260 for controlling at least some aspects of movement of the elevator car 210 in the elevator shaft 220, a door driving system 280 for driving movement of the car door 140 of the elevator car 210 between a closed position and an open position; and a door controller 270 for operating the door driving system 280 and for monitoring at least one aspect of operation of the door driving system 280.

Along the lines described in the foregoing, the elevator controller 260 may be arranged to control at least some aspects of movement of the elevator car 210 in the elevator shaft 220. The elevator controller 260 is typically installed outside the elevator car 210, for example at a landing floor, in a machine room (if any), or in suitable location in the elevator shaft 220 or in its close proximity, and it may comprise or may be provided using one or more computing apparatuses comprising respective one or more processors arranged to execute one or more computer programs to provide at least some aspects of operation of the elevator controller 260. Hence, the elevator controller 260 may be provided as an elevator control apparatus (e.g. using a single computer apparatus) or as an elevator control system (e.g. using one or more computer apparatuses). The elevator controller 260 is communicatively coupled to the door controller 270, where the communicative coupling between the elevator controller 260 and the door controller 270 may be provided using a wired communication network or communication link, using a wireless communication network or communication link, or using a combination of a wireless communication network or communication link and a wireless communication network or communication link. The elevator controller 260 may be further communicatively coupled to one or more further elevator controllers that may be arranged for controlling at least some aspect of movement of respective elevator cars in other elevator shafts and/or to an elevator group controller arranged to control at least some aspects related to movement of a plurality of elevator cars in a plurality of elevator shafts.

Along the lines described in the foregoing, the door driving system 280 may be arranged to drive movement of the car door 140 between the closed position and the open position. In this regard, the door driving system 280 may operate under control of the door controller 270, e.g. in accordance with one or more door control signals received from the door controller 270. The door driving system 280 may comprise an electric motor and a motor controller arranged to control operation of the electric motor that is coupled to the car door 140 via a transmission system such that operation of the electric motor causes linear movement of the elevator car door 140 in a direction that is substantially parallel with an opening in a wall of the elevator shaft 220 at the landing, thereby enabling movement of the car door 140 between the closed and open positions. The transmission system may be arranged to convert the rotary motion provided by the electric motor into the linear movement of the car door 140. Characteristics of the transmission system may be selected in accordance with requirements of a specific implementation of the elevator car 210, the car door 140 and/or the door driving system 280, and the transmission system may involve, for example, one or more of the following: a belt drive, a chain drive, a gear train.

The door controller 270 is typically installed in the elevator car 210, for example in suitable location in the interior of the elevator car 210 (e.g. in a ceiling structure of the elevator car 210) or on the exterior of the elevator car 210 (e.g. on the roof of the elevator car 210). The door controller 270 may comprise or may be provided using a computing apparatus comprising one or more processors arranged to execute one or more computer programs to provide at least some aspects of operation of the door controller 270. Hence, the door controller 270 may be provided as a door controller apparatus. Along the lines described in the foregoing, the door controller 270 is communicatively coupled to the elevator controller 260, whereas the door controller 270 is further communicatively coupled to the door driving system 280, where the communicative coupling between the door controller 270 and the door driving system 280 may be provided using a wired or wireless communication network and/or communication link.

In the following examples, where applicable, the term elevator door 130, 140 is applied to refer to one or both of the car door 140 and the landing door 130 as an editorial choice made in the interest of ensuring clarity and brevity of description via avoidance of extensive repetition of the terms car door 140 and landing door 130 throughout the examples. As already mentioned, the door coupler mechanism 230 may be arranged vice versa compared to one as explained in the foregoing description, i.e. so that the coupler vanes 120 as the coupling elements are mounted on the landing door 130 and the elevator door lock rollers 110 are mounted on the car door 140. Also, from this point of view the use of the term elevator door 130, 140 in a manner as described herein is justified.

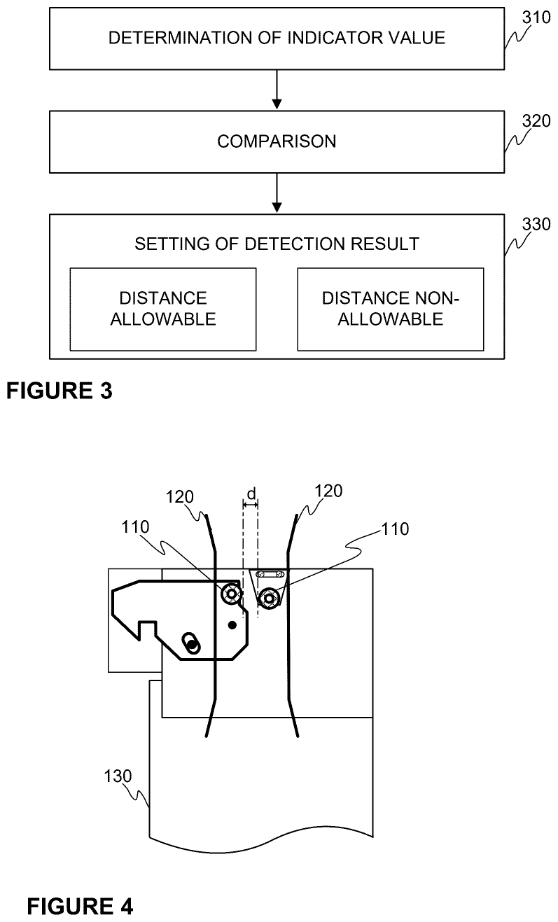

Next, at least some aspects of the invention are described by referring to FIG. 3 schematically illustrating a method for evaluating a distance of elevator door lock rollers 110 of an elevator door according to an example. The method is performed by a computing system which may e.g. correspond to the elevator controller 260, the elevator door controller 270 or any other computing apparatus configured to perform the method as described herein.

In step 310 an indicator value of a distance of elevator door lock rollers 110 is determined 310. The determination 310 is based on data descriptive of the distance of the elevator door lock rollers 110 that is received, or obtained, by the computing system performing the method. Thus, the data descriptive of the distance of the elevator door lock rollers 110 refers to any data applicable to indicate the distance d between two lock rollers 110 as schematically shown in FIG. 4. In other words, the distance d may represent a value in a predefined direction, such as in a horizontal direction (i.e. substantially in the direction of opening and closing of the elevator door and, thus, substantially transversally with respect to a travel direction of the elevator car 210 in the elevator shaft 220).

The data descriptive of the distance d of the elevator lock rollers 110 may be received in various manners. In accordance with the present invention the data descriptive of the distance of the elevator door lock rollers 110 corresponds to data representing a characteristic of an elevator door motor during a movement of the elevator door especially during an opening cycle of the elevator door. In some approaches data obtained during the closing cycle may be used as an additional data in checking the state of the door lock rollers 110. The characteristic of the elevator door motor may refer to a belt force generated by the elevator door motor during the opening cycle of the elevator door, or to a torque generated by the elevator door motor during the opening cycle of the elevator door or to an input current of the elevator door motor during the opening cycle of the elevator door. Specifically, for the purpose of the present invention a monitoring period from the opening cycle of the elevator door is determined as described in more detail in the forthcoming description.

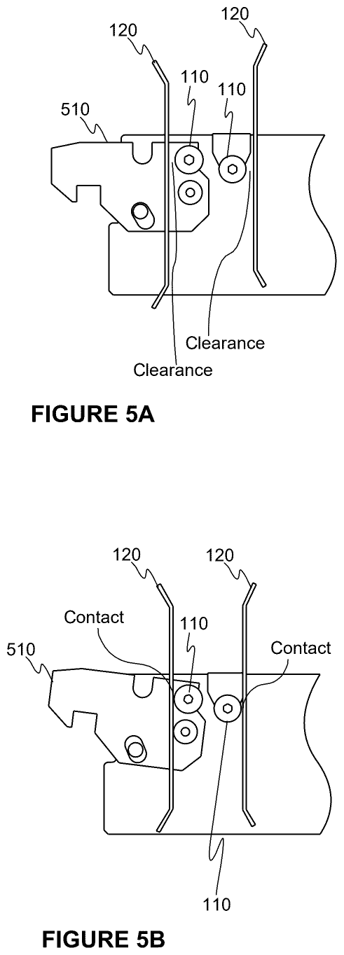

In order to bring further insight into the present invention it is hereby referred to FIGS. 5A and 5B. FIG. 5A illustrates schematically the elevator door lock rollers 110 of the elevator door, e.g. the landing door 130, and the coupler vanes 120 of the elevator door, e.g. the car door 140, in a situation that the elevator car 210 resides at the landing floor. As can be seen from FIG. 5A there is arranged so-called clearance, or clearance area, between the door lock roller 110 and the respective coupler vane 120. The aim of the clearance is to confirm that the lock rollers 110 arrive to the slot defined by the coupler vanes 120 when the elevator car 210 arrives at the landing floor. Now, in response to a predefined event the elevator controller 260 may generate a control signal causing the coupler vanes 120 to start moving towards each other to reach, or squeeze, at least one of the door lock rollers 110. The generation of the control signal by the elevator controller 260 and a receipt of it by the elevator door controller 270 makes the latter to control the door drive system 280 accordingly as is known. As a result, the coupler vanes 120, or at least one of them travels over the clearance area and, thus, reach the door lock roller(s) 110. In the example as shown in FIG. 5A it is necessary that at least the coupler vane 120 in the left side reaches the respective door lock roller 110 (the left lock roller) in order to release a door lock latch denoted with 510 in FIGS. 5A and 5B. The phase when the coupler vane 120 in question contacts the door lock roller 110 until the release of door lock latch 510 from a respective lock counterpart through a rotation of an axis, i.e. the elevator door is unlocked (cf. the situation as shown in FIG. 5B, is called as a compression phase. After the compression phase the real opening phase of the elevator door starts since the door leaf/leaves start opening. The compression phase, i.e. its starting point and ending point, is possible to define at instants of time in a course of movement of the elevator door as described. Alternatively or in addition, the compression phase may be defined as belt positions within the opening cycle. Correspondingly to above, it is possible to define a belt position when the compression phase starts as well as a belt position when the compression phase ends. The belt positions is derivable from data obtainable e.g. from the door drive system 280, such as from an encoder data therefrom. Still further, the compression phase may also be defined with speed of the belt thus representing a movement speed of the elevator door. The movement speed may e.g. be defined on a basis of a travel distance of the door defined by a series of (at least two) positions of the elevator door over a respective time window which travel distance is determinable e.g. from the encoder data and the time may be measured otherwise.

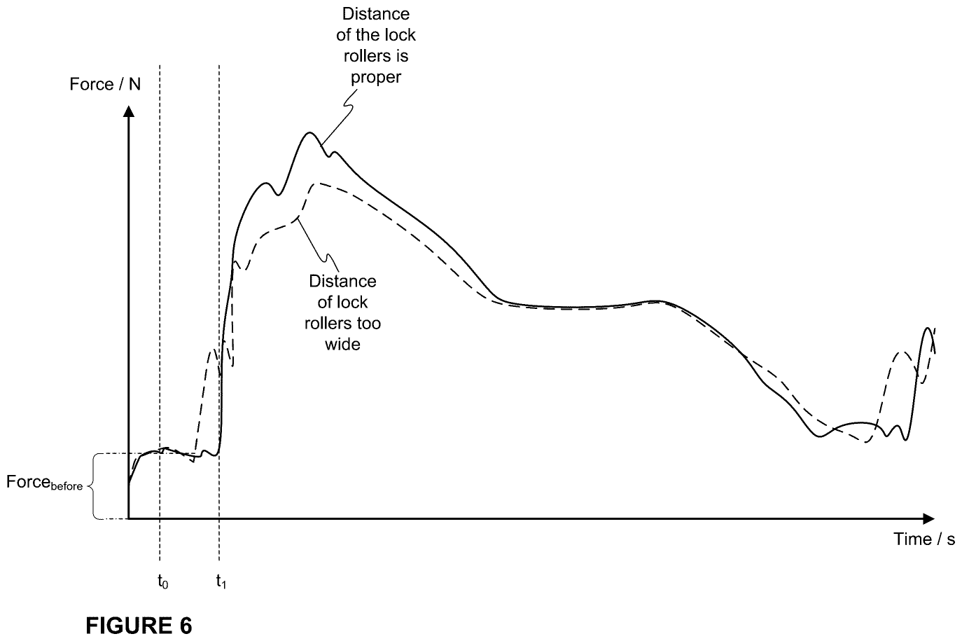

The compression phase may also be detected from data representing a characteristic of an elevator door motor during opening cycle of the elevator door. Aspects in relation to this are provided in the forthcoming description by referring to FIG. 6. FIG. 6 illustrates schematically a force generated by the door motor over a time during an opening cycle of the elevator door. The graph drawn with the solid line shows a proper operation of the elevator door in a situation that the distance of the door lock rollers 110 is allowable, i.e. as defined for the elevator door in question e.g. as a design value representing a proper distance. In other words, the force generated by the electric motor starts moving the coupler vanes 120 (cf. force_{before}) and when the clearance area is passed the coupler vane(s) hits the respective lock roller 110 and this occurs at the instant of time denoted with to in FIG. 6 and the compression phase starts. The movement of the coupler vanes 120 with the car door 140 continues after the contact between the coupler vane 120 and the respective lock roller 110 and at the instant of time denoted with t₁ the compression phase ends, i.e. the door lock hatch is released. In response to this the force is rapidly increased at the instant of time t₁ when the door opening phase actually begins. In other words, the electric motor is requested to generate a force to follow the motion defined by a door opening curve and it requires that the force is increased so as to make the coupled car door 140 and the landing door 130 to open. As mentioned, the instants of time t₀ and t₁ may be defined as elevator door belt positions within the travel path of the elevator door (i.e. in the travel path of the elevator door belt). Hence, as interpretable from FIG. 6 in a situation in which the distance d of the door lock rollers 110 is proper, i.e. corresponds the design parameter with a predefined accuracy, the increase in the force of the door motor occurs substantially at the instant of time t₁ when the compression phase ends e.g. in terms of the belt position. Hence, in some embodiments the invention may be based on a detection, on the basis of the received data descriptive of the force, or the torque, that the instants of time defining the compression period do not match with the monitoring period defined by the instants of time of a properly operating elevator door. For example, it may be detected that the force suddenly increases prior to the instant of time t₁ of the monitoring period wherein the increase shall occur if the elevator door operates properly, i.e. the door lock rollers 110 are properly positioned with respect to each other. Thus, the indicator value and the reference value may be defined and determined in accordance with the nature of the respective values.

FIG. 6 also schematically illustrates a graph on a force of the door belt generated by the door motor in a situation that the distance of door lock rollers 110 is too wide, i.e. they a misaligned with respect to each other. This is illustrated with the curve drawn with a dashed line in FIG. 6. As can be seen the curve differs from the curve of the proper distance of the lock rollers 110 and especially this can be seen from the event occurring before the instant of time t₁ in FIG. 6 as the force is rapidly increased before that instant of time. This occurs because as the distance of the lock rollers is too big, i.e. wide, and, thus, the contact between the coupler vane 120 and the respective lock roller 110 occurs earlier. As a result, the compression phase ends earlier and is thus detectable from the force curve as seeable from FIG. 6. The above-described matter means that the defined belt positions in the optimal situation do not coincide in the situation where the door lock rollers 110 are misaligned, i.e. the distance d is too wide.

Based on the foregoing description it is possible to generate an indicator value of the distance of the elevator door lock rollers 110 from the force curve as the characteristic of the elevator door motor as mentioned. More specifically, in the context of the force applied as the characteristic the determination 310 of the indicator value may be performed mathematically as an integral of the belt force generated by the door motor over a period of time defined by time instants t₀ and t₁ as follows:

$${force}_{integral , compress} = {\int }_{{t}_{0}}^{{t}_{1}} ( measured force - {force}_{before} ) dt ,$$

where t₀ is the time when the compression of one, or both, lock roller(s) 110 starts (the contact occurs) and t₁ is when the phase shifts from the compression phase to the door opening phase, i.e. defines the end of the compression period. Moreover, the measured force refers to the actual force with which the door belt is driven and it is determined e.g. by measuring it, calculating it from predefined parameters (cf. e.g. motor current and rotor angle) or estimated by applying a predefined estimation model thereto. The force_{before}, in turn, refers to the force applied to the belt before the contact of the lock roller(s) and the coupler vane(s), i.e. prior to the compression period. The force_{before} is subtracted from the measured force in order to bring out the events occurring during the coupling and before the actual door opening begins. For avoidance of doubt, it is clear that the force integrated in the above-described manner over the period of time defined by the instants of time t₀ and t₁ is greater in the situation that the distance d of the door lock rollers 110 is too wide compared to the optimal distance. For avoidance of doubt, it is worth mentioning that even if the instant of time t₀ is indicated to refer to the instant when the contact occurs, it is also possible to define as an instant of time, or a position, or a speed, occurring before the contact. This also enables the determination of the force, i.e. the indicator value, in the above-described manner. Naturally, in such case the instant of time to, or a (trigger) position so or a (trigger) speed v₀ (see below), is to be defined so that the indicator value generated is accurate enough for the purpose of the present invention. The application of the instant of contact as the instant of time t₀ defining the start of the monitoring period is a preferred approach due to its accuracy to represent the start of the phenomenon under interest.

In the description above at least some aspects of the present invention are described through an arrangement in which the monitoring period is defined as time window defined by instants of time t₀ and t₁. As mentioned, the monitoring period may also be defined as belt positions as data descriptive of the belt position is derivable from the door drive system, e.g. based on data obtained from an encoder of the door motor. Hence, the monitoring period, and thus the compression period, is possible to define as a first position s₀ and as a second position s₁ of the door belt. In such an approach, the indicator value descriptive of the distance of the elevator door lock rollers 110 may be defined as a displacement of the door belt between the positions s₀ and s₁. In other words, the determination 310 of the indicator may be performed by applying the above defined equation so that the force is determined by integrating the force over the displacement wherein the displacement is defined with the positions s₀ and s₁. Naturally, the reference value is determined accordingly.

Still further, the monitoring period, and thus also the compression period may be defined with speed of the belt thus representing a movement speed of the elevator door. Hence, the monitoring period may start when a predefined speed v₀ is detected and end in response to a detection that another speed v₁ is reached wherein the speed v₁ is higher than the speed v₀. Thus, the corresponding integral over speed may be calculated to evaluate the distance of the lock rollers 110 of the respective elevator door 130, 140. Again, the reference value is determined accordingly to be applicable in the comparison of the indicator value defined based on the speed.

In the foregoing the force generated by the elevator door motor is used as the characteristic of the elevator door motor, but correspondingly a torque generated by the door motor or an input current of the elevator door motor, or even or i_{q} (quadrature/torque producing current in vector control of the electric door motor) may be applied to in a corresponding manner by determining the integral over the monitoring period. This is because the relation of the mentioned characteristics may be expressed as follows:

force=k₁*torque=k₂*i_{q}=k₂*i

where k₁ and k₂ are constants. Worth noting is that the last equation k₂*i is valid only for a specific control approach for specific motor types, i.e. the permanent magnet synchronous motors (PMSM) wherein the magnetization-axis current component is zero.

Now, as the fundamental thinking behind the approach according to the present invention is shown in the foregoing it is now reverted back to FIG. 3 and the method according to the present invention. In other words, as the step 310 generates the indicator value descriptive of the distance of the elevator door lock rollers 110 the determined indicator value is compared 320 to a reference value. The reference value advantageously represents a situation when a distance of the lock rollers 110 that is allowable, cf. optimal distance, and the instants of time t₀ and t₁ are determined on the basis of the door setup when the door lock rollers 110 reside in the optimal, i.e. desired, distance from each other. Hence, the reference value may be determined by driving the elevator door in the optimal setup to receive data of the applied parameter, cf. force or torque, and the reference value may be mathematically determined on the basis of data in the manner as described (cf. the integral). Naturally, the reference value may be expressed, or defined, as a non-allowable value or values (e.g. as range(s)) of the time/distance. Thus, in accordance with the comparison 320 between the indicator value and the reference value, a detection result is set 330 to express one of the following: i) the distance is in allowable range, ii) the distance deviates from the allowable range. The setting of the detection result 330 may cause the computing system performing the method to generate a request with a signal to provide the information to one or more pre-defined parties. For example, the signal may be generated towards a maintenance system in order to indicate the state of the elevator door to the maintenance system and, thus, e.g. to achieve a maintenance visit to correct the deviation if such exists in the distance between the lock rollers 110.

In other words, the instants of time t₀ and t₁ are determined from the properly operating elevator door and the values of them are stored in a memory accessible by the computing system performing the method and they define the monitoring period for evaluating the operation of the elevator door. Thus, when the elevator door is driven during the use of the elevator the computing system receives the data descriptive of the distance of the elevator door lock rollers 110, such as the force or torque values, at least over the monitoring period defined by the instants of time t₀ and t₁ and determines the indicator value of the monitoring period from the data representing the operation over the monitoring period. In other words, the indicator value is determined 310 in the same manner as the reference value and the result of comparison indicates, based on an evaluation of a correspondence of the indicator value and the reference value, if the door lock rollers 100 is still positioned with respect to each other in an acceptable manner, i.e. the distance is proper.

As described, the entity configured to perform the method may be an applicable computing system, and the result of the method may be exchanged between entities over a communication channel (e.g. wired or wireless) implemented between the entities. For example, the method may be executed in a so-called edge device and the result is transmitted periodically to cloud for data analytics and service needs are sent to technician when the data shows poor condition of the elevator door in question. Alternatively, an elevator controller may be configured to perform the method or even the door controller.

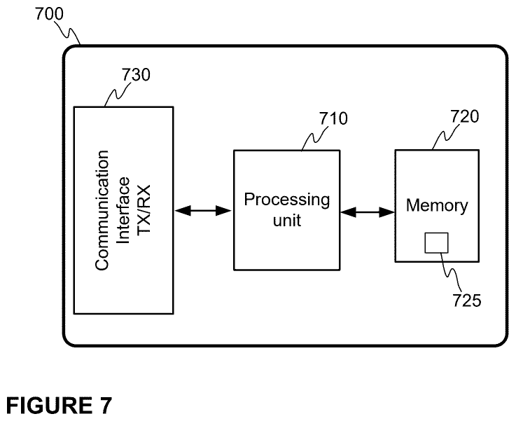

An example of such an apparatus configurable to implement the method as the computing system is schematically illustrated in FIG. 7. Thus, the apparatus of FIG. 7 may be configured to perform an evaluation of a distance of elevator door lock rollers of an elevator door. For the sake of clarity, it is worthwhile to mention that the block diagram of FIG. 7 depicts some components of an entity that may be employed to implement a functionality of the apparatus. The apparatus of FIG. 7 comprises a processor 710 and a memory 720. The memory 720 may store data, such as pieces of data as described like the instants of time t₀ and t₁, or respective positions, defining the monitoring period during the opening cycle of the elevator door, but also computer program code 725 causing the association in the described manner. The apparatus may further comprise a communication interface 730, such as a wireless communication interface or a communication interface for wired communication, or both to communicate with other entities as described. The communication interface 730 may thus comprise one or more modems, antennas, and any other hardware and software for enabling an execution of the communication e.g. under control of the processor 710. Furthermore, I/O (input/output) components may be arranged, together with the processor 710 and a portion of the computer program code 725, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 720 and at least a portion of the computer program code 725 stored therein may further be arranged, with the processor 710, to cause the apparatus to perform at least a portion of a method as is described herein. The processor 710 may be configured to read from and write to the memory 720. Although the processor 710 is depicted as a respective single component, it may be implemented as respective one or more separate processing components. Similarly, although the memory 720 is depicted as a respective single component, it may be implemented as respective one or more separate components, some, or all of which may be integrated/removable and/or may provide permanent/semi-permanent/dynamic/cached storage.

The computer program code 725 may comprise computer-executable instructions that implement functions that correspond to steps implemented in the method when loaded into the processor 710 of the respective computing system 700. As an example, the computer program code 725 may include a computer program consisting of one or more sequences of one or more instructions. The processor 710 is able to load and execute the computer program by reading the one or more sequences of one or more instructions included therein from the memory 720. The one or more sequences of one or more instructions may be configured to, when executed by the processor 710, cause the apparatus, such as a computer, to perform a method as described. Hence, the apparatus may comprise at least one processor 710 and at least one memory 720 including the computer program code 725 for one or more programs, the at least one memory 720 and the computer program code 725 configured to, with the at least one processor 710, cause the apparatus implementing the computing system 700 to perform the method.

The computer program code 725, or at least some portion of it, may be provided e.g. a computer program product comprising at least one computer-readable non-transitory medium having the computer program code 725 stored thereon, which computer program code 725, when executed by the processor 710 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 725 may comprise a proprietary application, such as computer program code for causing an execution of the method in the manner as described in the description herein.

Any of the programmed functions mentioned may also be performed in firmware or hardware adapted to or programmed to perform the necessary tasks.

For the sake of completeness, it is worthwhile to mention that the entity performing the method in the role of the computing system 700 may also be implemented with a plurality of apparatuses, such as the one schematically illustrated in FIG. 7, as a distributed computing environment corresponding to a computing system. For example, one of the apparatuses may be communicatively connected with the other apparatuses and e.g. share the data of the method, to cause another apparatus to perform at least one other portion of the method. As a result, the method performed in the distributed computing environment generates the control signal indicative of the assignment of the responsibility as described. For example, in some embodiments a first computing apparatus may perform the step denoted with 310 and the computing apparatus may refer to the door controller 270, for example. The first apparatus may be configured to transmit the determined indicator value to another computing apparatus referring e.g. to data centre or cloud wherein the other steps of the method, i.e. the steps denoted with 320 and 330 in FIG. 3 are executed. The respective entity may further generate a maintenance request to a predefine entity in a situation that a need for maintenance is detected as already described.

As already mentioned in the foregoing description, the computing system 700 as shown in FIG. 7 may reside in a data centre or implemented as an edge device between the network and the elevator system. In some approaches at least some functionalities of the computing system 700 to execute the method may be implemented in the elevator controller 260 or in the elevator door controller 270 as already mentioned in the foregoing description.

The invention as described is advantageous in confirming during an installation phase of the elevator that all doors at different landing doors operate properly at least in terms of positions of the elevator door lock rollers 110. The invention improves an efficiency of the installation as it only requires monitoring of the door opening at the landing doors and in response to a detection that the elevator door is not operating properly, a technician may immediately re-adjust the door lock rollers 110 to overcome the situation.

The specific examples provided in the description given above should not be construed as limiting the applicability and/or the interpretation of the appended claims. Lists and groups of examples provided in the description given above are not exhaustive unless otherwise explicitly stated.

1. A method for evaluating a distance of elevator door lock rollers of an elevator door, the method, performed by a computing system, comprises:
determining, on the basis of data descriptive of the distance of the elevator door lock rollers, an indicator value of the distance of the elevator door lock rollers,
comparing the indicator value to a reference value,
setting, in accordance with a comparison between the indicator value and the reference value, a detection result to express one of the following: i) the distance is in allowable range, ii) the distance deviates from the allowable range.

2. The method according to claim 1, wherein the data descriptive of the distance of the elevator door lock rollers corresponds to data representing a characteristic of an elevator door motor during an opening cycle of the elevator door.

3. The method according to claim 2, wherein the data representing a characteristic of an elevator door motor is received over a monitoring period during the opening cycle of the elevator door, the monitoring period corresponds to a compression period of the elevator door comprising elevator door lock rollers positioned in an allowable distance from each other.

4. The method according to claim 2, wherein the at least one characteristic is at least one of the following: a force of a door belt generated by the elevator door motor during the opening cycle of the elevator door; a torque generated by the elevator door motor during the opening cycle of the elevator door; an input current of the elevator door motor during the opening cycle of the elevator door.

5. The method according to claim 1, wherein the indicator value is determined as at least one of the following: an integral of the characteristic of the elevator door motor over instants of time (t₀, t₁) defining the monitoring period; an integral of the characteristic of the elevator door motor over positions of door belt (s₀, s₁) defining the monitoring period; an integral of the characteristic of the elevator door motor over speeds of door belt (v₀, v₁) defining the monitoring period.

6. The method according to claim 1, wherein the reference value is determined over the monitoring period wherein the distance of the elevator door lock rollers is allowable.

7. The method according to claim 1, the method further comprises:
generating a request of a maintenance visit to a maintenance system in response to a setting of the detection result to express that the distance deviates from the allowable range.

8. A computing system for evaluating a distance of elevator door lock rollers of an elevator door, the computing system is configured to:
determine, on the basis of data descriptive of the distance of the elevator door lock rollers, an indicator value of the distance of the elevator door lock rollers,
compare the indicator value to a reference value,
set, in accordance with a comparison between the indicator value and the reference value, a detection result to express one of the following: i) the distance is in allowable range, ii) the distance deviates from the allowable range.

9. The computing system according to claim 8, wherein the data descriptive of the distance of the elevator door lock rollers corresponds to data representing a characteristic of an elevator door motor during an opening cycle of the elevator door.

10. The computing system according to claim 9, wherein the computing apparatus is configured to receive the data representing a characteristic of an elevator door motor over a monitoring period during the opening cycle of the elevator door, the monitoring period corresponds to a compression period of the elevator door comprising elevator door lock rollers positioned in an allowable distance from each other.

11. The computing system according to claim 9, wherein the at least one characteristic is at least one of the following: a force of a door belt generated by the elevator door motor during the opening cycle of the elevator door; a torque generated by the elevator door motor during the opening cycle of the elevator door; an input current of the elevator door motor during the opening cycle of the elevator door.

12. The computing system according to claim 8, wherein the computing system is configured to determine the indicator value as at least one of the following: an integral of the characteristic of the elevator door motor over instants of time (t₀, t₁) defining the monitoring period; an integral of the characteristic of the elevator door motor over positions of door belt (s₀, s₁) defining the monitoring period; an integral of the characteristic of the elevator door motor over speeds of door belt (v₀, v₁) defining the monitoring period.

13. The computing system according to claim 8, wherein the computing system is configured to determine the reference value over the monitoring period wherein the distance of the elevator door lock rollers is allowable.

14. The computing system according to claim 8, the computing system is further configured to:
generate a request of a maintenance visit to a maintenance system in response to a setting of the detection result to express that the distance deviates from the allowable range.

15. The computing system according to claim 8, wherein the computing system is at least one of:
an elevator controller; an elevator door controller; a data centre; an edge device.

16. An elevator system comprising:
an elevator door arranged moveable between an open position and a closed position;
a door driving system for driving a movement of the elevator door; and
a computing system according to claim 8.

17. A non-transitory computer-readable medium storing a computer program comprising instructions to cause a computing system to execute the steps of the method of claim 1.

18. The method according to claim 3, wherein the at least one characteristic is at least one of the following: a force of a door belt generated by the elevator door motor during the opening cycle of the elevator door; a torque generated by the elevator door motor during the opening cycle of the elevator door; an input current of the elevator door motor during the opening cycle of the elevator door.

19. The method according to claim 2, wherein the indicator value is determined as at least one of the following: an integral of the characteristic of the elevator door motor over instants of time (t₀, t₁) defining the monitoring period; an integral of the characteristic of the elevator door motor over positions of door belt (s₀, s₁) defining the monitoring period; an integral of the characteristic of the elevator door motor over speeds of door belt (v₀, v₁) defining the monitoring period.

20. The method according to claim 3, wherein the indicator value is determined as at least one of the following: an integral of the characteristic of the elevator door motor over instants of time (t₀, t₁) defining the monitoring period; an integral of the characteristic of the elevator door motor over positions of door belt (s₀, s₁) defining the monitoring period; an integral of the characteristic of the elevator door motor over speeds of door belt (v₀, v₁) defining the monitoring period.
